(19) United States
(12) Patent Application Publication
(10) Pub. No.: US 2011/0232111 A1
(43) Pub. Date: Sep. 29, 2011

(54) MACHINE FOR OPENING A CAN LID AND METHOD FOR EMPTYING THE CAN

(75) Inventors: Patrice Duval, Villevneuve Les Avignon (FR); Jean-Jacques Marchal, Lieuran-Cabrieres (FR); Luc Collette, Vedene (FR)

(73) Assignee: AREVA NC, PARIS (FR)

(21) Appl. No.: 13/123,883

(22) PCT Filed: Oct. 13, 2009
(86) PCT No.: PCT/EP09/63313

§ 371 Date: Apr. 12, 2011

(30) Foreign Application Priority Data
Oct. 15, 2008 (FR) 08 57003

(51) Int. Cl. B67B 7/46; B67B 7/90

(52) U.S. Cl. 30/411

(57) ABSTRACT

This can opening machine comprises a lower guide ring to center the top of the single-piece can, comprising a centering chamfered face and an upper stop face. A piston arranged in the tool for cutting out the can lid is pushed downwards by a spring extending low enough to separate the cut out lid from the tool. The lid remains in the can during turning and content emptying operations.

This invention relates to a machine for opening a can lid and a method for emptying the can; in particular it can be applied to the treatment of nuclear fuel powders.

It is an improvement to French patent application published as number 2 845 371 in which the can was placed on a support and then opened by lowering a toothed circular ring that detached the lid from the remainder of the can.

There were disadvantages with this method. The detached lid remained fixed to the machine during the can emptying process and therefore the opening machine was immobilised during this time. Many cans remained jammed on the machine due to large tolerances necessary during their manufacturing or deformations caused by shocks applied to them. Finally, there were still uncertainties about whether the can would effectively be opened.

This invention eliminates these disadvantages. In its most general form, it relates to a machine for opening a can lid, comprising particularly a can support and a press comprising a mobile tool body facing the support and free to move towards it, the press comprising a tool for cutting the can lid, characterised in that the press comprises a device facing the lid, free to move towards the lid relative to the press and capable of separating the lid from the tool and pushing it back into the can. In particular, this arrangement eliminates the first disadvantage mentioned by guaranteeing that the lid is immediately detached from the machine after it has been cut off and it accompanies the remainder of the can during the remaining part of the process; the machine is then free to open another can during this time, without being immobilised.

According to another embodiment, the press is provided with an assembly free to move relative to the tool to hold the can in place, the moving assembly being moved towards the can by at least one spring and comprising a plane support face for an upper edge of the can that surrounds the lid, characterised in that the moving assembly also comprises a conical face guiding the can to centre it. It has been found that these measures reduce much of the risk of cans getting jammed in the machine.

According to another embodiment, the machine is provided with sensors for detecting when the tool is pushed into the can, the sensors are placed on detection heads that can be adjusted independently in the direction in which the press is free to move. The fine position adjustment available with this arrangement defines the position of the tool precisely and therefore assures that the opening procedure takes place satisfactorily.

The invention will now be described with reference to the figures in which:

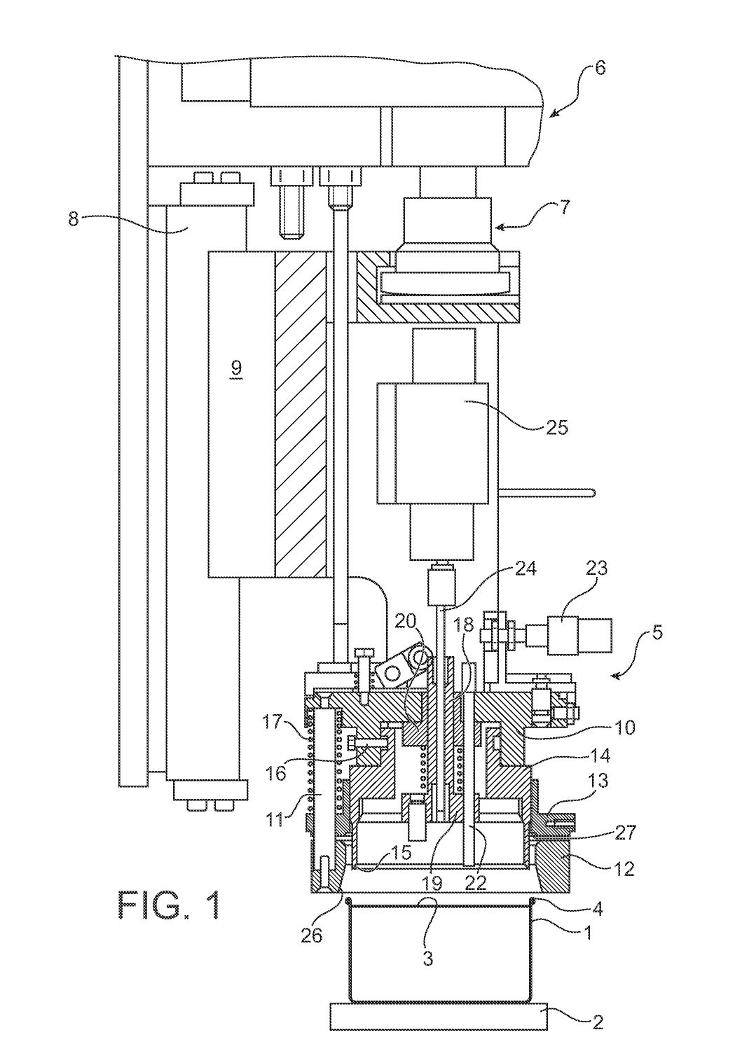

FIG. 1 shows an earlier machine resembling the machine described in the patent mentioned above,

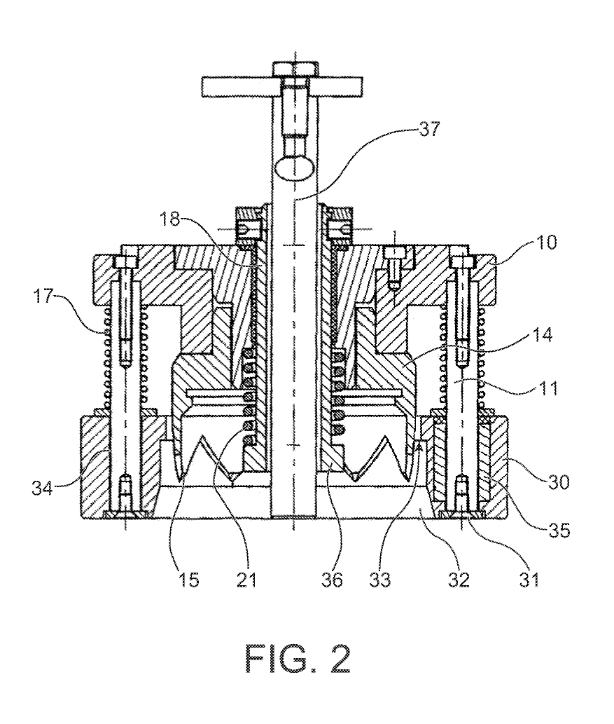

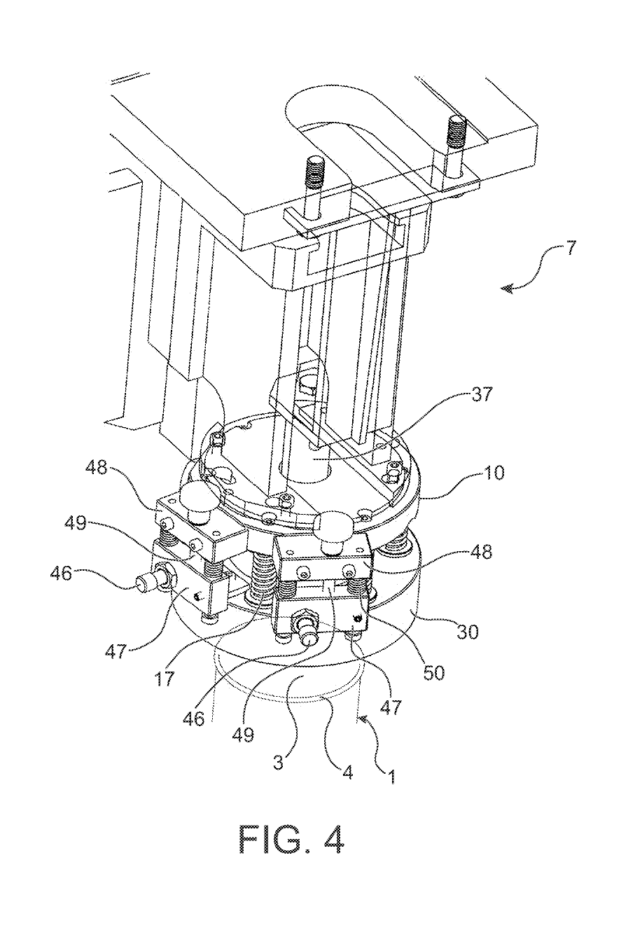

FIG. 2 and FIG. 4 show a sectional view and a perspective view of the invention,

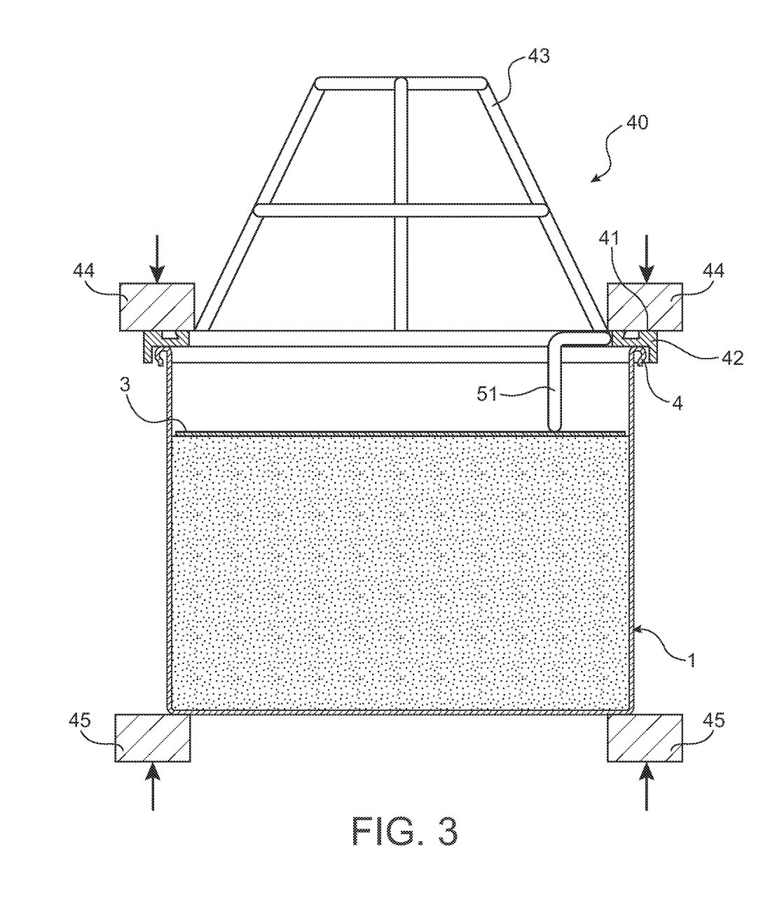

FIG. 3 shows equipment associated with the invention.

We will start by describing prior equipment that is similar to the equipment in French patent mentioned above and that will be referred to if necessary for further details about operation, some general aspects and some equipment of the machine unrelated to the invention. A can 1 that might contain nuclear fuel powders is placed on a support. It comprises an upper lid 3 surrounded by a rim 4 that rises slightly above the lid. The machine that opens the can 1 comprises a tool body 5 fitted on a frame 6 and free to move relative to it in the vertical direction by a press 7; the tool body 5 is guided by adjustment of a rib 9 that forms part of the body in a slide 8 built on the frame 6.

The tool body 5 comprises a plate 10 with a lower part that supports a group of peripheral columns 11 oriented downwards and to the lower end of which a guide ring 12 is screwed. A mobile end plate 13 slides on the peripheral columns 11 between the plate 10 and the guide ring 12. A tool 14, the active part of which is a toothed ring 15 facing downwards is surrounded by the guide ring 12 and the mobile end plate 13, and it is held in place by the plate 10 through assembly screws 16. Springs 17 are engaged around the peripheral columns 11 and force the mobile end plate 13 downwards. A piston 18 extends at the centre of the device under the tool 14, on the bottom of which there is a magnet 19. The piston 18 is free to move inside a reaming in the plate 10 on which a bearing 20 is fitted, as far as a lower stop position; a compressed spring 21 between the bearing 20 and the magnet 19 brings the piston 18 to the lower position but does not resist it rising towards the plate 10. A pin 22 also slides in a reaming in the plate 10, and extends underneath the magnet 19 when a lower stop position is reached. Its upper end then remains below an induction sensor 23 mounted on the upper face of the plate 10. There is another pin 24 activated by an electromagnet 25 fitted on the top of the tool body 5, also extending in the vertical direction, through the piston 18 but without coming underneath the magnet 19 in the usual position.

When the can 1 is placed on the support 2, the tool body 5 is lowered by the press 7. The guide ring 12 engages on the upper edge 4 of the can 1 through a chamfered internal face 26 that is tapered downwards and centres the can 1 relative to the tool body 5. The upper edge 4 finally comes into contact with a bottom face 26 of the mobile end plate 13 that holds the can 1 in place, and the remainder of the downwards movement of the tool body 5 is accompanied by compression of the springs 17, the mobile end plate 13 that stops in contact with the upper edge 4, remaining at the same elevation while the remainder of the tool body 5 continues to move downwards. The toothed ring 15 reaches the lid 3 and perforates it and cuts it. The magnet 19 comes into contact with the cut out lid 3 and grips it. The pin 22 is lifted by the lid 3 until its upper end comes within range of the inductive sensor 23, such that the presence of a lid 3 attached to the magnet 19 is proven.

Lifting the tool body 5 releases the lid 3 from the remainder of the can 1, which is then opened. The can 1 is then transferred to a can turning installation so that its contents flow out. It is then brought back and the electromagnet 25 is switched on so that the pin 24 moves downwards and separates the lid 3 from the magnet 19; the lid 3 drops into the can 1 which is then taken away.

Bringing back the can 1 to retrieve the lid 3 can unnecessarily take time. The can 1 can also easily get jammed in the guide ring 12 due to the large tolerances with which it is made. The mobile end plate 13 does not slide easily around the tool 14 and it can also get seized.

The invention improves the machine as described above. The tool body is modified. As shown in FIG. 2, apart from the plate 10, peripheral columns 11, springs 17 and the tool 14 which remain unchanged, it also comprises a new guide ring 30 that in this case is free to move between one end of the lower stop at the end of the peripheral columns 11, and the plate 10. Its internal face comprises both a chamfered conical face 32 tapered near the bottom that will centre the upper edge 4 of the can 1, and a stop face 33 facing downwards that the upper edge 4 must reach so that it can be held in place. The guide ring 30 is guided by bearings with roller elements mounted on peripheral columns 11 and smooth bearings 35. The tall guide face between the tool 14 and the mobile end plate 13 is eliminated in this case, and there is a large clearance between the tool 14 and the lower guide ring 30. The tool body also comprises the mobile piston 18 and springs 21 that move it downwards. However, the magnet 19 is not present in this case and the piston 18 supports a single lower collar 36 with no magnetic properties. Finally, the figure shows an ejection pin 37 that passes vertically through the plate 10 and piston 18.

The device operates as follows. The can 1 is once again placed on the support 2. The press appears similar to the press used in the previous machine and lowers the tool body. The lower guide ring 30 centres the can 1 through its chamfered face 32 and it moves upwards until the lower edge 4 has reached the stop face 33, but the tool 14 continues to drop and cuts the lid 3. The piston 18 also continues to move downwards and pushes the cut out lid 3 towards the bottom of the can 1 despite the deflection of the spring 21. When the tool body is raised, it returns to the position in FIG. 2, and the pin 37 projecting under the tool 14 and the piston 18 separates the lid 3 from it if it was held in place.

Therefore, the lid 3 remains in the can 1. Emptying is done as described with reference to FIG. 3. The can 1 fits on one flange called the lower flange 40. A rim 41 is placed on the upper edge 4 and extends around it with a collar 42; the remainder of the lower flange 40 is an open lattice 43 of bars comprising a stud 51 extending beyond the rim 41. The stud 51 is in a peripheral position in which it can incline the cut out lid 3 by bringing it down to its location. The can 1 and the lower flange 40 are kept forced into contact with each other by jaws 51 and 45 that form part of a can turning machine that is not shown in more detail. However, the assembly can tip such that the lower flange 40 comes under the can 1. The powder pushes the lid 3 back, and the lid tilts when it touches the stud 51, thus opening the can 1 wide. Tilting of the lid 3 enables the powder contained in the can 1 to pour easily through the opening thus formed. The lid is held in place by the open lattice 43.

Another aspect of the invention will be described with reference to FIG. 4. The presence of the can 1 under the press is detected by the lower guide ring 30 being pushed in. This pushing in is measured by inductive sensors 46. In this case, they are not installed rigidly relative to the plate 10, but they are installed on adjustable heads 47 connected to fixed heads 48 screwed to the plate 10, through micrometric screws 49 that independently adjust their level depending on the calibration. Springs 50 compressed between heads 47 and 48 keep their spacing to the adjusted value. Safer detection can thus be obtained.

1. Machine for opening the lid of a can comprising particularly a can support and a press free to move towards the support and facing the support, the press comprising a tool for cutting the can lid, characterized in that the press comprises a device facing the lid, free to move towards the lid relative to the press and capable of separating the lid from the tool and pushing it back into the can.

2. Machine for opening a can lid according to claim 1, characterised in that the device is a piston sliding in the press and brought back to the lid by a spring.

3. Machine for opening a can lid according to claim 1, in which the press is provided with an assembly free to move relative to the tool to hold the can in place, the moving assembly being moved towards the can by at least one spring and comprising a plane support face for an upper edge of the can that surrounds the lid, characterized in that the moving assembly also comprises a conical face guiding the can to center it.

4. Machine for opening a can lid according to claim 1, comprising sensors for detecting when the tool is pushed into the can, characterised in that sensors are placed on heads that can be adjusted independently in the direction in which the press is free to move.

5. Method for emptying cans, using a machine having a can support and a press free to move towards the support and facing the support, the press having a tool for cutting the can lid, and having a device facing the lid, comprising the steps of:
moving the device towards the lid relative to the press and separating the lid from the tool and pushing it back into the can, so as to cut out a can lid and pushing the lid back into the can, then turning the can over on a flange provided with a stud oriented upwards so that the can enters the flange and the stud pushes the lid back into the can while being inclined from the can.
